(19) United States
(12) Patent Application Publication
(10) Pub. No.: US 2006/0203445 A1
(43) Pub. Date: Sep. 14, 2006

(54) Heat-dissipating structure for flat panel display

(75) Inventors: Sheng-Hsiang Hsu, Miao Li County (TW); Bor-Bin Chou, Miao Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/359,521

(22) Filed: Feb. 23, 2006

(30) Foreign Application Priority Data
Mar. 11, 2005 (TW) 94107519

(51) Int. Cl. G06F 1/20

(52) U.S. Cl. 361/687; 361/700; 361/704

(57) ABSTRACT

A heat-dissipating structure for a flat panel display comprises a heat-collector plate, a soft thermal-pad and at least one heat-sink component. The heat-collector plate is made of metal material having a first-face, a second-face and a plurality of edge-sides. The first-face is contact with a back-bezel of the flat panel display. The soft thermal-pad is made of soft material with high thermal conductivity. The soft thermal-pad has a bottom-face and a top-face. The bottom-face is contact with the second-face. The top-face is contact with a heat-sink structure of an electric unit of the flat panel display. The heat-sink component is connected with at least one of the edge-side of the heat-collector plate. The heat-sink component is capable of conducting heat and expanding heat sink area.

### BACKGROUND OF THE INVENTION

(1) Field of the Invention

The present invention generally relates to a heat-dissipating structure and particularly relates to a heat-dissipating structure for a flat panel display.

(2) Description of the Prior Art

A flat panel display, such as a Plasma Display Panel (PDP) and a LCD (Liquid Crystal Display) monitor, generally has a thin shape. Accordingly, a heat-dissipating efficiency becomes an important issue to the flat panel display.

Please refer to FIG. 1. A conventional flat panel display 2 comprises a display screen 4, a back bezel 6 and many other electric units enclosed by a front frame of the display screen 4 and the back bezel 6. The electric units generate heat while they are operated. A power supply element 8, which is one of the electric units, generates heat of a particularly high heat power. A conventional solution is to dissipate heat by air convection through a gap between the power supply element 8 and the back bezel 6.

However, owing to a thin appearance of the flat panel display, the gap between the power supply element 8 and the back bezel 6 is very reduced. The heat-dissipating efficiency is therefore limited, especially in the condition that the heat is only dissipated by air convection. These usually leads to over heat from the electric units and reduce product life time of the flat panel display 2.

### SUMMARY OF THE INVENTION

An objective of the present invention is to provide a heat-dissipating structure for a flat panel display with a good heat-dissipating efficiency.

A heat-dissipating structure for a flat panel display comprising a heat-collector plate, a soft thermal-pad and at least one heat-sink component is provided.

The heat-collector plate is made of metal material, such as aluminum or copper, having a first-face, a second-face and a plurality of edge-side. The first-face is contact with a back-bezel of the flat panel display.

The soft thermal-pad is made of soft material with high thermal conductivity, such as boron-nitride or graphite. The soft thermal-pad has a bottom-face and a top-face. The bottom-face is contact with the second-face. The top-face is contact with a heat-sink structure of an electric unit of the flat panel display.

The heat-sink component is connected with at least one of the edge-side of the heat-collector plate. The heat-sink component is capable of conducting heat and expanding heat sink area. The heat-sink component includes a heat-pipe or a graphite flake.

Accordingly, by utilizing the present heat-dissipating structure for the flat panel display, which comprises above mentioned elements such as the heat-collector plate, the soft thermal-pad and the heat-sink component, the heat generated from the electric units of the flat panel display is able to be conducted well.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

The present invention will now be specified with reference to its preferred embodiment illustrated in the drawings, in which

FIG. 1 shows a cross section view of a conventional flat panel display.

FIG. 2 shows a cross section view of a flat panel display according to the present invention.

FIG. 3 shows a rear view of a heat-dissipating structure of the flat panel display.

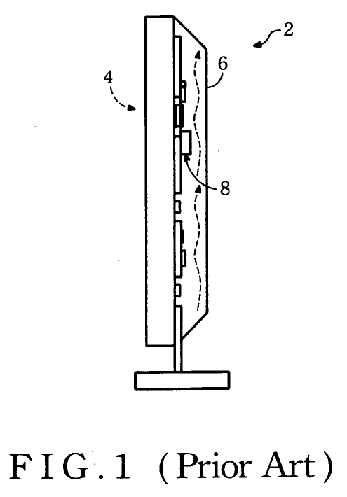

### DESCRIPTION OF THE PREFERRED EMBODIMENT

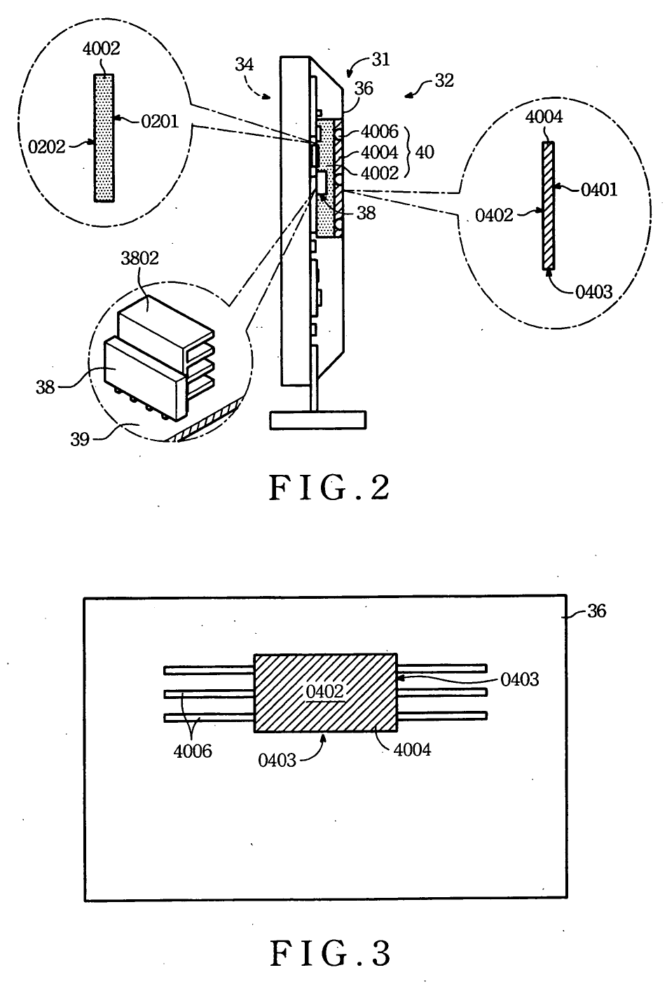

Please refer to FIG. 2 and FIG. 3. FIG. 2 shows a cross section view of a flat panel display 32 according to the present invention. FIG. 3 shows a rear view of a heat-dissipating structure 31 of the flat panel display 32. The heat-dissipating structure 31 of the present invention comprises a heat-collector plate 4004, a soft thermal-pad 4002 and at least one heat-sink component 4006. The flat panel display 32 comprises a display screen 34, a back bezel 36 and many other electric units 38 enclosed by a front frame of the display screen 34 and the back bezel 36. The electric units 38 generate heat while they are operated. A power supply element, which is one of the electric units 38, generates heat of a particularly high heat power. Generally, a heat-sink structure 3802 is disposed on the electric unit 38 for enhancing heat sink efficiency.

The heat-collector plate 4004 has a first-face 0401, a second-face 0402 and a plurality of edge-sides 0403. The first-face 0401 is contact with the back-bezel 36 of the flat panel display 32. The heat-collector plate 4004 is made of metal material, such as aluminum, copper or the mix.

The soft thermal-pad 4002 is made of soft material with high thermal conductivity, such as boron-nitride, graphite or the mix. The soft thermal-pad 4002 has a bottom-face 0201 and a top-face 0202. The bottom-face 0201 is contact with the second-face 0402 of the heat-collector plate 4004. The top-face 0202 is contact with the heat-sink structure 3802 of the electric unit 38 of the flat panel display 32.

However, because of the heat-sink structure 3802 disposed on the electric unit 38, it usually more protrudes out than other elements of the flat panel display 32. In other words, the heat-sink structure 3802 has a height taller than the other elements. Considering to this aspect, the thickness of the heat-collector plate 4004 or the thickness of the soft thermal-pad 4002 can be adjustable, so as to achieve the purpose of making the heat-collector plate 4004, the soft thermal-pad 4002 and the heat-sink structure 3802 being contact with each other and to achieve a goal of conducting heat.

The practicable embodiments of the heat-sink structure 3802 of the electric unit 38 have several different forms. The electric unit 38 is disposed on a circuit board 39, which is disposed behind the display screen 34, within the flat panel display 32. The heat-sink structures 3802 includes a plurality of fins. In one embodiment, which is not illustrate by the figure, the fins can substantially being vertical to the circuit board 39. Alternatively, in the embodiment illustrate in FIG. 2, the fins can be arranged parallely to the circuit board 39. And the soft thermal-pad 4002 is contact with the outer fin of the heat-sink structure 3802. Through this preferred embodiment, a better heat dissipating efficiency is obtained.

In the present invention, the power supply element is one kind of the electric unit 38 that generating particularly more heat than the other kind. Therefore it is usually disposed at the central portion of the circuit board 39. Accordingly, the heat-collector plate 4004 and the soft thermal-pad 4002 are disposed at corresponding portion to the electric unit 38. As shown in FIG. 3, the disposed position of the heat-collector plate 4004 is substantially at the central part of the back-bezel 36 to achieve better heat dissipating efficiency.

The heat-sink component 4006 is connected with at least one of the edge-side 0403 of the heat-collector plate 4004. The heat-sink component 4006 is capable of conducting heat of the heat-collector plate 4004 and expanding heat sink area of the heat-dissipating structure 31. In practice, the heat-sink component 4006 includes a heat-pipe or a graphite flake.

While the present heat-dissipating structure 31 is applied to a flat panel display 32 using a back-bezel 36 made of metal material, in this situation, the heat-sink component 4006 is preferable being contact with a inner-face of the back-bezel 36, so as to dissipate heat effectively.

In addition, a heat sink compound is able to be used in the present invention. In one embodiment, there is the heat sink compound applied between the back-bezel 36 and the heat-collector plate 4004. In one embodiment, there is the heat sink compound applied between the back-bezel 36 and the heat-sink component 4006.

Accordingly, by utilizing the present heat-dissipating structure 4004 for the flat panel display 32, which comprises above mentioned elements such as the heat-collector plate 4004, the soft thermal-pad 4002 and the heat-sink component 4006, the heat generated from the electric units 38 of the flat panel display 32 is able to be conducted well. The present invention also provides an enlarged heat sink area, so as to dissipate the heat effectively by effective air convection. As a result, advantages generated from the present invention are obvious and remarkable.

With the example and explanations above, the features and spirits of the invention are hopefully well described. Those skilled in the art will readily observe that numerous modifications and alterations of the device may be made while retaining the teaching of the invention. Accordingly, the above disclosure should be construed as limited only by the metes and bounds of the appended claims.

I claim:

1. A heat-dissipating structure for a flat panel display, comprising:
a heat-collector plate made of metal material having a first-face, a second-face and a plurality of edge-sides, the first-face being contact with a back-bezel of the flat panel display;
a soft thermal-pad made of soft material with high thermal conductivity, the soft thermal-pad having a bottom-face and a top-face, the bottom-face being contact with the second-face, the top-face being contact with a heat-sink structure of an electric unit of the flat panel display; and
at least one heat-sink component connected with the heat-collector plate, wherein the heat-sink component is capable of conducting heat and expanding heat sink area.

2. The heat-dissipating structure of claim 1, wherein the heat-sink component comprises a heat pipe.

3. The heat-dissipating structure of claim 1, wherein the heat-sink component comprises a graphite flake.

4. The heat-dissipating structure of claim 1, wherein the soft thermal-pad comprises material selecting from the group of boron-nitride and graphite.

5. The heat-dissipating structure of claim 1, wherein the heat-collector plate comprises material selecting from the group of aluminum and copper.

6. The heat-dissipating structure of claim 1, wherein the back-bezel comprises metal material.

7. The heat-dissipating structure of claim 1, wherein the heat-sink component is contact with an inner-face of the back-bezel.

8. The heat-dissipating structure of claim 7, wherein a heat sink compound is applied between the back-bezel and the heat-collector plate, and a heat sink compound is applied between the back-bezel and the heat-sink component.

9. The heat-dissipating structure of claim 1, wherein the electric unit is a power supply element.

10. The heat-dissipating structure of claim 1, wherein the heat-collector plate has a thickness being flexible to the height of the heat-sink structure of the electric unit.

11. The heat-dissipating structure of claim 1, wherein the soft thermal-pad has a thickness being flexible to the height of the heat-sink structure of the electric unit.
